(19) United States
(12) Patent Application Publication
(10) Pub. No.: US 2024/0110484 A1
(43) Pub. Date: Apr. 4, 2024

(54) VIBRATION DAMPING SYSTEM FOR TURBOMACHINE NOZZLE OR BLADE USING VOLUTE SPRING VIBRATION DAMPING ELEMENT

(71) Applicant: General Electric Company, Schenectady, NY (US)

(72) Inventors: James Zhang, Simpsonville, SC (US); John McConnell Delvaux, Fountain Inn, SC (US); Zachary John Snider, Simpsonville, SC (US)

(21) Appl. No.: 17/937,851

(22) Filed: Oct. 4, 2022

(51) Int. Cl. F01D 5/16; F01D 9/04; F01D 25/06

(52) U.S. Cl. CPC F01D 5/16; F01D 9/041; F01D 25/06; F05D 2220/30; F05D 2230/60; F05D 2240/12; F05D 2240/30; F05D 2260/96

(57) ABSTRACT

A vibration damping system includes a vibration damping element for a turbomachine nozzle or blade. A body opening extends through the turbomachine nozzle or blade between the tip end and the base end thereof. A vibration damping element includes a volute spring vibration damping element configured to be installed within the body opening in the turbomachine nozzle or blade. The volute spring vibration damping element includes a spiral coil of a metal sheet strip with a surface of the metal sheet strip contacting itself in a direction of an axis of the coil. The body opening has an inner dimension, and the volute spring vibration damping element has an outer dimension sized to frictionally engage the inner dimension of the body opening to dampen vibration. In certain embodiments, the body opening and the volute spring vibration damping element each have a conical perspective shape.

### TECHNICAL FIELD

The disclosure relates generally to damping vibration in a turbomachine nozzle or blade. Further, the disclosure relates to a vibration damping system including a vibration damping element including a volute spring within a body opening in the turbomachine nozzle or blade.

### BACKGROUND

One concern in turbine operation is the tendency of the turbine blades or nozzles to undergo vibrational stress during operation. In many installations, turbines operate under conditions of frequent acceleration and deceleration. During acceleration or deceleration of the turbine, the airfoils of the blades are, momentarily at least, subjected to vibrational stresses at certain frequencies and in many cases to vibrational stresses at secondary or tertiary frequencies. Nozzle airfoils experience similar vibrational stress. Variations in gas temperature, pressure, and/or density, for example, can excite vibrations throughout the rotor assembly, especially within the nozzle or blade airfoils. Gas exiting upstream of the turbine and/or compressor sections in a periodic, or “pulsating,” manner can also excite undesirable vibrations. When an airfoil is subjected to vibrational stress, its amplitude of vibration can readily build up to a point which may negatively affect gas turbine operations or component life.

### BRIEF DESCRIPTION

All aspects, examples and features mentioned below can be combined in any technically possible way.

An aspect of the disclosure provides a vibration damping element for a vibration damping system for a turbomachine nozzle or blade, the vibration damping element comprising: a volute spring vibration damping element configured to be mounted within a body opening in the turbomachine nozzle or blade, the volute spring vibration damping element including a spiral coil of a metal sheet strip with a surface of the metal sheet strip contacting itself in a direction of an axis of the spiral coil; wherein the body opening has an inner dimension and the volute spring vibration damping element has an outer dimension sized to frictionally engage the inner dimension of the body opening to dampen vibration.

Another aspect of the disclosure includes any of the preceding aspects, and the body opening and the volute spring vibration damping element each have a conical perspective shape along at least a portion of respective lengths thereof.

Another aspect of the disclosure includes any of the preceding aspects, and the surface of the metal sheet strip frictionally engages with itself to dampen vibration.

Another aspect of the disclosure includes any of the preceding aspects, and the body opening extends through a body of the turbomachine nozzle or blade between a tip end and a base end thereof; and wherein the volute spring vibration damping element has a first, free end and a second end fixed relative to one of the base end and the tip end.

Another aspect of the disclosure includes any of the preceding aspects, and the second end of the volute spring vibration damping element is fixed relative to the tip end of the body of the turbomachine nozzle or blade, and the first, free end extends towards the base end.

Another aspect of the disclosure includes any of the preceding aspects, and the second end of the volute spring vibration damping element is fixed relative to the base end of the body of the turbomachine nozzle or blade, and the first, free end extends towards the tip end.

Another aspect of the disclosure includes any of the preceding aspects, and the volute spring vibration damping element and the body opening having mating circular cross-sectional shapes.

Another aspect of the disclosure includes any of the preceding aspects, and the volute spring vibration damping element and the body opening having mating oblong cross-sectional shapes.

Another aspect of the disclosure includes any of the preceding aspects, and the volute spring vibration damping element and the body opening having mating non-circular cross-sectional shapes.

Another aspect of the disclosure relates to a turbomachine nozzle or blade having a vibration damping system, the turbomachine nozzle or blade comprising: a body opening extending through a body of the turbomachine nozzle or blade between a tip end and a base end thereof; and a vibration damping element disposed in the body opening, the vibration damping element including a volute spring vibration damping element configured to be mounted within the body opening, the volute spring vibration damping element including a spiral coil of a metal sheet strip with a surface of the metal sheet strip contacting itself in a direction of an axis of the spiral coil; wherein the body opening has an inner dimension and the volute spring vibration damping element has an outer dimension sized to frictionally engage the inner dimension of the body opening to dampen vibration.

Another aspect of the disclosure includes any of the preceding aspects, and the body opening and the volute spring vibration damping element each have a conical perspective shape along at least a portion of respective lengths thereof.

Another aspect of the disclosure includes any of the preceding aspects, and the surface of the metal sheet strip frictionally engages with itself to dampen vibration.

Another aspect of the disclosure includes any of the preceding aspects, and wherein the volute spring vibration damping element has a first, free end and a second end fixed relative to one of the base end and the tip end.

Another aspect of the disclosure includes any of the preceding aspects, wherein a fixture member is secured to the second end of the volute spring vibration damping element to prevent the volute spring vibration damping element from rotating within the body opening and from pulling away from the fixture member.

Another aspect of the disclosure includes any of the preceding aspects, and the second end of the volute spring vibration damping element is fixed relative to the tip end of the body of the turbomachine nozzle or blade, and the first, free end extends towards the base end.

Another aspect of the disclosure includes any of the preceding aspects, and the second end of the volute spring vibration damping element is fixed relative to the base end of the body of the turbomachine nozzle or blade, and the first, free end extends towards the tip end.

Another aspect of the disclosure includes any of the preceding aspects, and the volute spring vibration damping element and the body opening having mating circular cross-sectional shapes.

Another aspect of the disclosure includes any of the preceding aspects, and the volute spring vibration damping element and the body opening having mating non-circular cross-sectional shapes.

Another aspect of the disclosure includes a method of installing a vibration damping element in a body opening in a turbomachine nozzle or blade, the method comprising: coiling a volute spring vibration damping element to a coiled position from a free position to reduce an outer dimension of the volute spring vibration damping element from a first outer dimension to a second, smaller outer dimension, the volute spring vibration damping element including a spiral coil of a metal sheet strip with a surface of the metal sheet strip contacting itself in a direction of an axis of the coil; positioning the volute spring vibration damping element in the coiled position within the body opening in the turbomachine nozzle or blade, the body opening having an inner dimension; and releasing the volute spring vibration damping element in the body opening such that a third outer dimension of the volute spring vibration damping element frictionally engages the inner dimension of the body opening, whereby the volute spring vibration damping element dampens vibration during operation of the turbomachine nozzle or blade.

Another aspect of the disclosure includes any of the preceding aspects, and the volute spring vibration damping element has a first end and a second end, and the body opening extends through a body of the turbomachine nozzle or blade between a tip end and a base end thereof, and further comprising fixing the second end of the volute spring vibration damping element relative to one of the base end and the tip end of the turbomachine nozzle or blade.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional view of an illustrative turbomachine in the form of a gas turbine system;

FIG. 2 shows a cross-sectional view of a portion of an illustrative turbine section of a turbomachine, according to embodiments of the disclosure;

FIG. 3 shows a perspective view of an illustrative turbomachine nozzle including a vibration damping system, according to embodiments of the disclosure;

FIG. 4 shows a perspective view of an illustrative turbine blade including a vibration damping system, according to embodiments of the disclosure;

FIG. 5 shows a schematic cross-sectional view of a turbomachine nozzle or blade having a vibration damping system including a volute spring vibration damping element, according to embodiments of the disclosure;

FIG. 6 shows a schematic cross-sectional view of a turbomachine nozzle or blade having a vibration damping system including a volute spring vibration damping element, according to other embodiments of the disclosure;

FIG. 7 shows a perspective view of part of a volute spring vibration damping element, according to embodiments of the disclosure;

FIG. 8 shows a cross-sectional view of a volute spring vibration damping element, according to embodiments of the disclosure;

FIG. 9 shows a schematic cross-sectional view of a volute spring vibration damping element, according to embodiments of the disclosure;

FIG. 10 shows a schematic cross-sectional view of a turbomachine nozzle or blade having a vibration damping system including a volute spring vibration damping element, according to other embodiments of the disclosure;

FIG. 11 shows a transparent perspective view of a closure and fixing member for a body opening and a volute spring vibration damping element, according to embodiments of the disclosure;

FIG. 12 shows a perspective view of a volute spring vibration damping element having an oblong or oval cross-sectional shape, according to embodiments of the disclosure;

FIG. 13 shows a cross-sectional view along view line 13-13 in FIG. 12;

FIG. 14 shows a perspective view of a volute spring vibration damping element having a generally rectangular cross-sectional shape, according to embodiments of the disclosure;

FIG. 15 shows a cross-sectional view along view line 15-15 in FIG. 14;

FIG. 16 shows a perspective view of coiling a volute spring vibration damping element from a free, released position, according to embodiments of the disclosure;

FIG. 17 shows a perspective view of a volute spring vibration damping element in a coiled position, according to embodiments of the disclosure; and

FIG. 18 shows a cross-sectional view of inserting a volute spring vibration damping element in a coiled position into a body opening in a turbomachine nozzle or blade, according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant machine components within a turbine. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. It is often required to describe parts that are disposed at different radial positions with regard to a center axis. The term “radial” refers to movement or position perpendicular to an axis. For example, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the turbomachine.

In addition, several descriptive terms may be used regularly herein, as described below. The terms “first,” “second,” and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present, and that the description includes instances where the event occurs or the component is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Embodiments of the disclosure provide vibration damping systems including a vibration damping element for a turbomachine nozzle (stationary vane) or blade (rotating blade). The systems may include a body opening extending through a body of the turbomachine nozzle or blade between the tip end and the base end thereof, e.g., through the airfoil among potentially other parts of the nozzle or blade. A vibration damping element includes a volute spring vibration damping element configured to be mounted within the body opening in the turbomachine nozzle or blade. The volute spring vibration damping element includes a spiral coil of a metal sheet strip with a surface of the metal sheet strip contacting itself generally in a direction of an axis of the coil. The body opening has an inner dimension and the volute spring vibration damping element has an outer dimension sized to frictionally engage the inner dimension of the body opening to dampen vibration.

In certain embodiments, the body opening and the volute spring vibration damping element each have a conical perspective shape along at least a portion of respective lengths thereof. The volute spring vibration damping element may be fixed at one end relative to the body opening. The vibration damping element reduces nozzle or blade vibration with a simple arrangement and does not add much extra mass to the nozzle or blade so that it generates low additional G-forces during use. Accordingly, the vibration damping element does not increase centrifugal force to the nozzle base end or blade tip end or require a change in nozzle or blade configuration. The vibration damping element is easily installed.

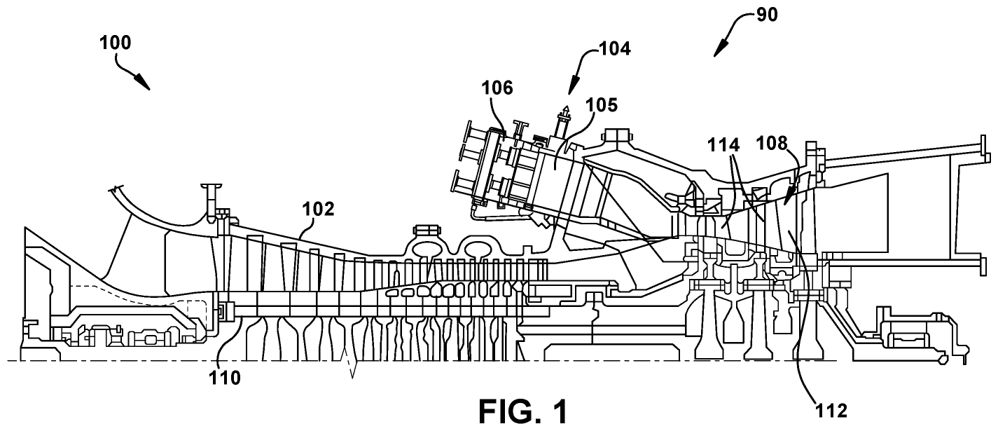

Referring to the drawings, FIG. 1 is a cross-sectional view of an illustrative machine including a turbine(s) to which teachings of the disclosure can be applied. In FIG. 1, a turbomachine 90 in the form of a combustion turbine or gas turbine (GT) system 100 (hereinafter, “GT system 100”) is shown. GT system 100 includes a compressor 102 and a combustor 104. Combustor 104 includes a combustion region 105 and a fuel nozzle section 106. GT system 100 also includes a turbine 108 (e.g., an expansion turbine) and a common compressor/turbine shaft 110 (hereinafter referred to as “rotor 110”).

GT system 100 may be a 7HA.03 engine, commercially available from General Electric Company, Greenville, S.C. However, the present disclosure is not limited to any one particular GT system and may be implemented in connection with other engines including, for example, the other HA, F, B, LM, GT, TM and E-class engine models of General Electric Company and engine models of other companies. More importantly, the teachings of the disclosure are not necessarily applicable to only nozzles or blades for a turbine in a GT system, and may be applied to practically any type of industrial machine or other turbomachine, e.g., steam turbines, jet engines, compressors (as in FIG. 1), turbofans, turbochargers, etc. Hence, reference to turbine 108 of GT system 100 is merely for descriptive purposes and is not limiting, and “turbomachine nozzle or blade” may apply to any nozzle or blade of any variety of turbomachine.

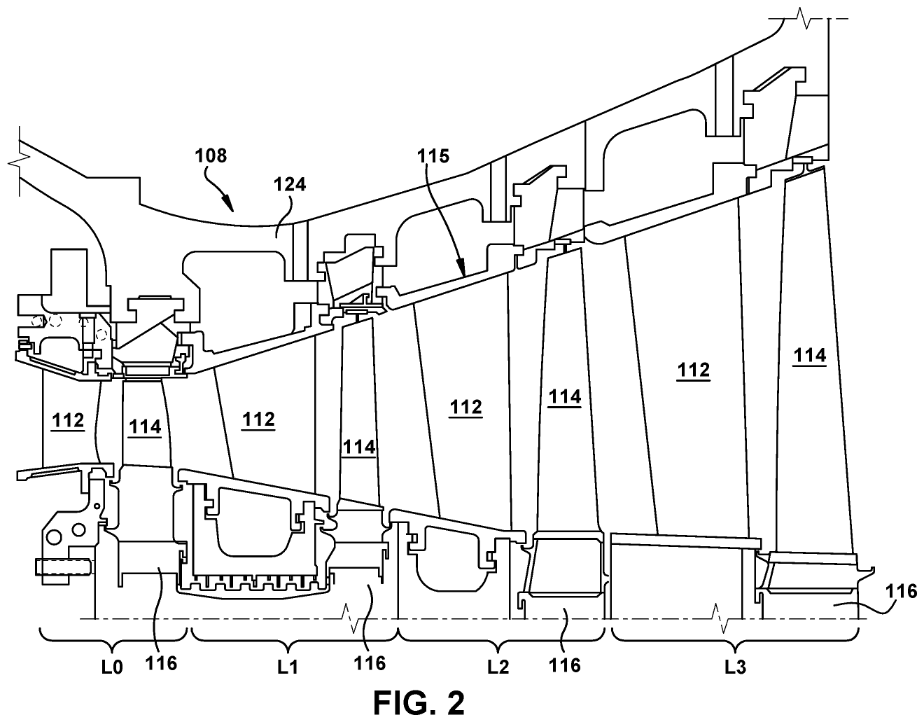

FIG. 2 shows a cross-sectional view of an illustrative portion of turbine 108. In the example shown, turbine 108 includes four stages L0-L3 that may be used with GT system 100 in FIG. 1. The four stages are referred to as L0, L1, L2, and L3. Stage L0 is the first stage and is the smallest (in a radial direction) of the four stages. Stage L1 is the second stage and is disposed adjacent the first stage L0 in an axial direction. Stage L2 is the third stage and is disposed adjacent the second stage L1 in an axial direction. Stage L3 is the fourth, last stage and is the largest (in a radial direction). It is to be understood that four stages are shown as one example only, and each turbine may have more or less than four stages.

A plurality of stationary turbine vanes or nozzles 112 (hereafter “nozzle 112,” or “nozzles 112”) may cooperate with a plurality of rotating turbomachineblades 114 (hereafter “blade 114,” or “blades 114”) to form each stage L0-L3 of turbine 108 and to define a portion of a working fluid path through turbine 108. Blades 114 in each stage are coupled to rotor 110 (FIG. 1), e.g., by a respective rotor wheel 116 that couples them circumferentially to rotor 110 (FIG. 1). That is, blades 114 are mechanically coupled in a circumferentially spaced manner to rotor 110, e.g., by rotor wheels 116. A static nozzle section 115 includes a plurality of stationary nozzles 112 mounted to a casing 124 and circumferentially spaced around rotor 110 (FIG. 1). It is recognized that blades 114 rotate with rotor 110 (FIG. 1) and thus experience centrifugal force, whereas nozzles 112 are static.

With reference to FIGS. 1 and 2, in operation, air flows through compressor 102, and pressurized air is supplied to combustor 104. Specifically, the pressurized air is supplied to fuel nozzle section 106 that is integral to combustor 104. Fuel nozzle section 106 is in flow communication with combustion region 105. Fuel nozzle section 106 is also in flow communication with a fuel source (not shown in FIG. 1) and channels fuel and air to combustion region 105. Combustor 104 ignites and combusts fuel to produce combustion gases. Combustor 104 is in flow communication with turbine 108, within which thermal energy from the combustion gas stream is converted to mechanical rotational energy by directing the combusted fuel (e.g., working fluid) into the working fluid path to turn blades 114. Turbine 108 is rotatably coupled to and drives rotor 110. Compressor 102 is rotatably coupled to rotor 110. At least one end of rotor 110 may extend axially away from compressor 102 or turbine 108 and may be attached to a load or machinery (not shown), such as, but not limited to, a generator, a load compressor, and/or another turbine.

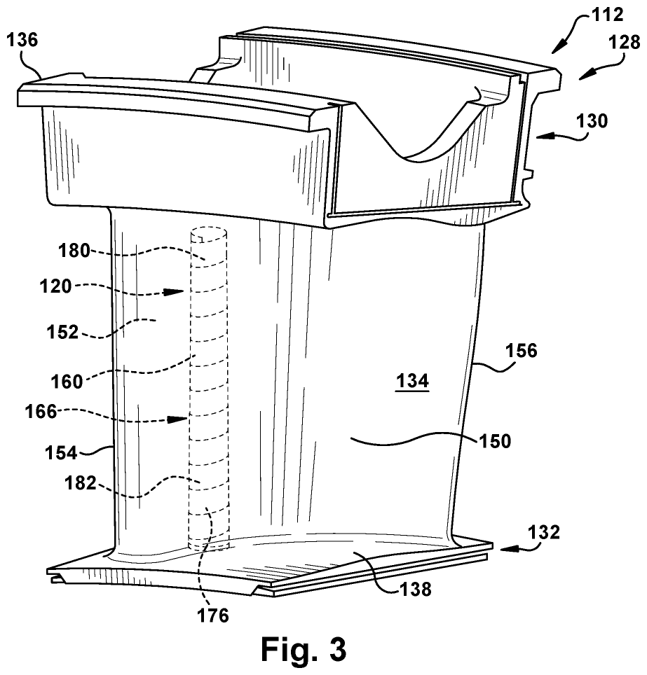

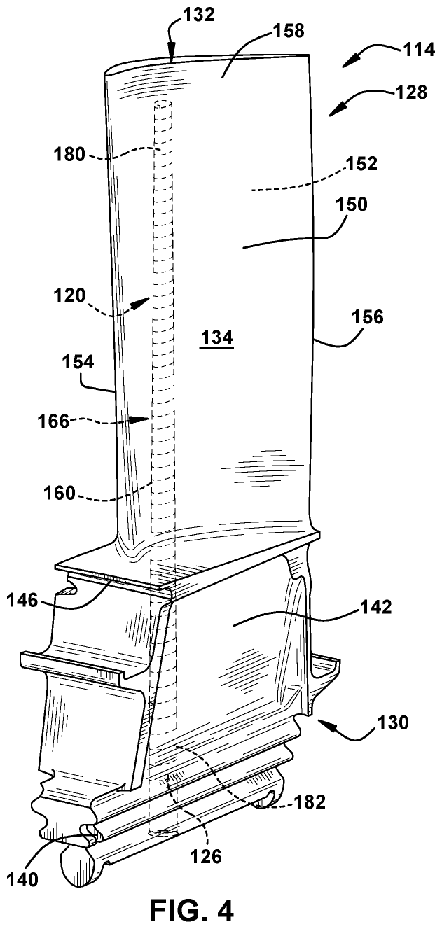

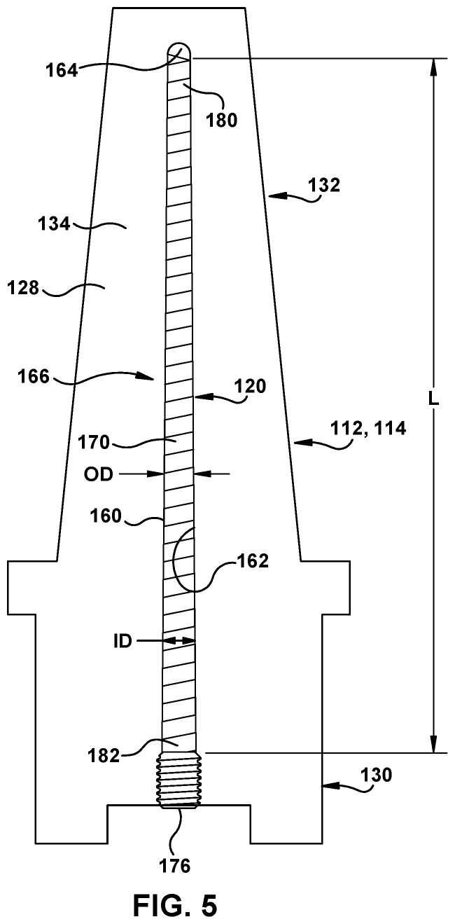

FIGS. 3 and 4 show perspective views, respectively, of a (stationary) nozzle 112 and a (rotating) blade 114, of the type in which embodiments of a vibration damping system 120 and a vibration damping element 166 of the present disclosure may be employed. As will be described herein, FIGS. 5, 6, 10 and 18 show schematic cross-sectional views of a nozzle 112 or blade 114 including vibration damping system 120, according to various embodiments of the disclosure.

Referring to FIGS. 3 and 4, each nozzle or blade 112, 114 includes a body 128 having a base end 130, a tip end 132, and an airfoil 134 extending between base end 130 and tip end 132. As shown in FIG. 3, nozzle 112 includes an outer endwall 136 at base end 130 and an inner endwall 138 at tip end 132. Outer endwall 136 couples to casing 124 (FIG. 2). As shown in FIG. 4, blade 114 includes a dovetail 140 at base end 130 by which blade 114 attaches to a rotor wheel 116 (FIG. 2) of rotor 110 (FIG. 2). Base end 130 of blade 114 may further include a shank 142 that extends between dovetail 140 and a platform 146. Platform 146 is disposed at the junction of airfoil 134 and shank 142 and defines a portion of the inboard boundary of the working fluid path (FIG. 2) through turbine 108.

It will be appreciated that airfoil 134 in nozzle 112 and blade 114 is the active component of the nozzle 112 or blade 114 that intercepts the flow of working fluid and, in the case of blades 114, induces rotor 110 (FIG. 1) to rotate. It will be seen that airfoil 134 of nozzle 112 and blade 114 includes a concave pressure side (PS) outer wall 150 and a circumferentially or laterally opposite convex suction side (SS) outer wall 152 extending axially between opposite leading and trailing edges 154, 156, respectively. Sidewalls 150 and 152 also extend in the radial direction from base end 130 (i.e., outer endwall 136 for nozzle 112 and platform 146 for blade 114) to tip end 132 (i.e., inner endwall 138 for nozzle 112 and a tip end 158 for blade 114). Note, in the example shown, blade 114 does not include a tip shroud; however, teachings of the disclosure are equally applicable to a blade including a tip shroud at tip end 158. Nozzle 112 and blade 114 shown in FIGS. 3-4 are illustrative only, and the teachings of the disclosure can be applied to a wide variety of nozzles and blades.

During operation of a turbine, nozzles 112 or blades 114 may be excited into vibration by a number of different forcing functions. For example, variations in working fluid temperature, pressure, and/or density can excite vibrations throughout the rotor assembly, especially within the airfoils and/or tips of the blades 114 or nozzles 112. Gas exiting upstream of the turbine section in a periodic, or “pulsating,” manner can also excite undesirable vibrations. The present disclosure reduces the vibration of a stationary turbomachine nozzle 112 or rotating turbomachine blade 114 without significant change of nozzle or blade design.

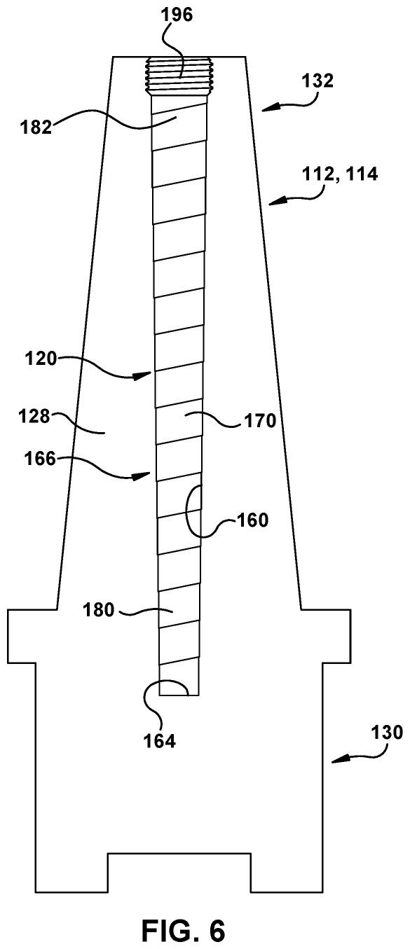

FIG. 5 shows a schematic cross-sectional view of nozzle 112 or blade 114 including vibration damping system 120, according to other embodiments of the disclosure. FIG. 6 shows a schematic cross-sectional view of nozzle 112 or blade 114 including vibration damping system 120, according to other embodiments of the disclosure. (Nozzle 112 in the schematic cross-sectional views of FIGS. 5, 6, 10 and 18 is shown flipped vertically compared to that shown in FIG. 3 and without inner endwall 138, for ease of description. It should be understood that references to base end 130 and tip end 132 may be reversed for nozzle 112, as compared to blade 114.) Vibration damping system 120 for turbomachine nozzle 112 or blade 114 may include a body opening 160 extending through body 128 between tip end 132 and base end 130 thereof and through airfoil 134. Body opening 160 may span part of the distance between base end 130 and tip end 132, or it may extend through one or more of base end 130 or tip end 132. Body opening 160 may originate at base end 130 of blade 114 (as shown in FIG. 4) or may originate at tip end 132 of nozzle 112 (as shown in FIG. 3).

Body opening 160 may be defined in any part of any structure of body 128. For example, where body 128 includes an internal partition wall (not shown), for example, for defining a cooling circuit therein, body opening 160 may be defined as an internal cavity in the partition wall in body 128. Body opening 160 generally extends radially in body 128. However, some angling, and perhaps curving, of body opening 160 relative to a radial extent of body 128 is possible. Body opening 160 has an inner surface 162. Body opening 160 may be formed using any now known or later developed technique, e.g., additive manufacturing during formation of nozzle or blade 112, 114, or drilling into an existing nozzle or blade 112, 114.

As shown for example in FIG. 5, body opening 160 may be open in base end 130 and terminate in tip end 132, or, as shown in FIG. 6, it may be open in tip end 132 and extend into base end 130. The open end may assist in assembling vibration damping system 120 in nozzle 112 or blade 114 and may allow retrofitting of the system into an existing nozzle or blade. Where body opening 160 extends through base end 130 as shown in FIG. 5, a closure or fixture member 176 for closing body opening 160 may be provided. Where body opening 160 extends through tip end 132, as shown in FIG. 6, a closure or fixing member 196 for body opening 160 may be provided. Closure or fixing members 176, 196 may also be employed to close body opening 160. Alternatively, as will be described, closure or fixing members 176, 196 may close body opening 160 and fix vibration damping element 166 in an operational state within body opening 160.

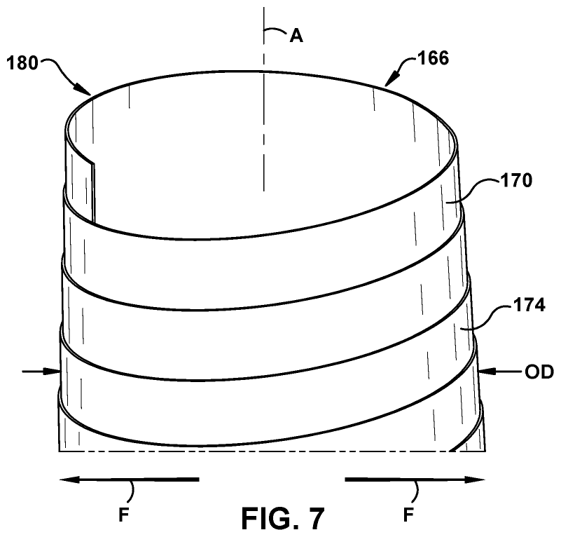

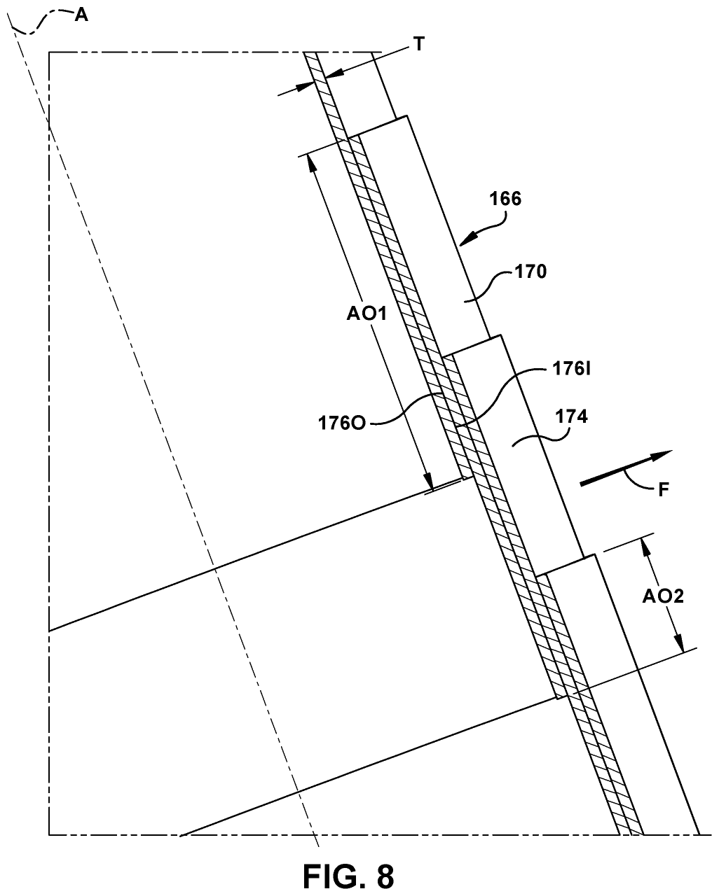

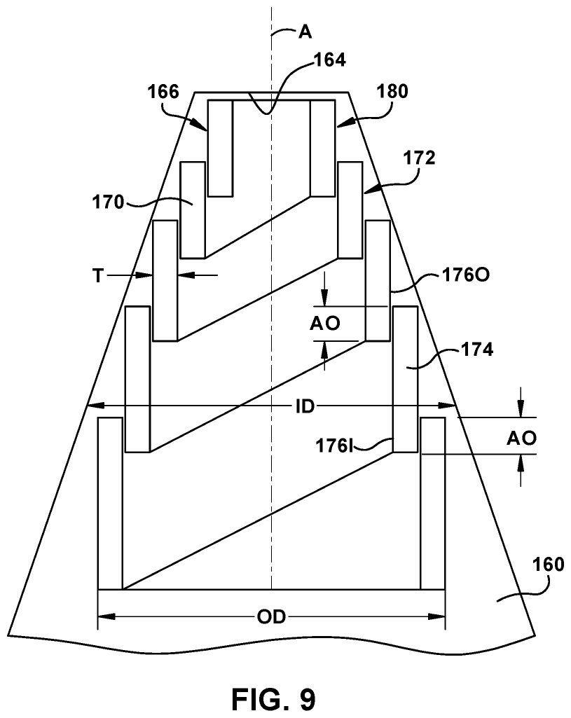

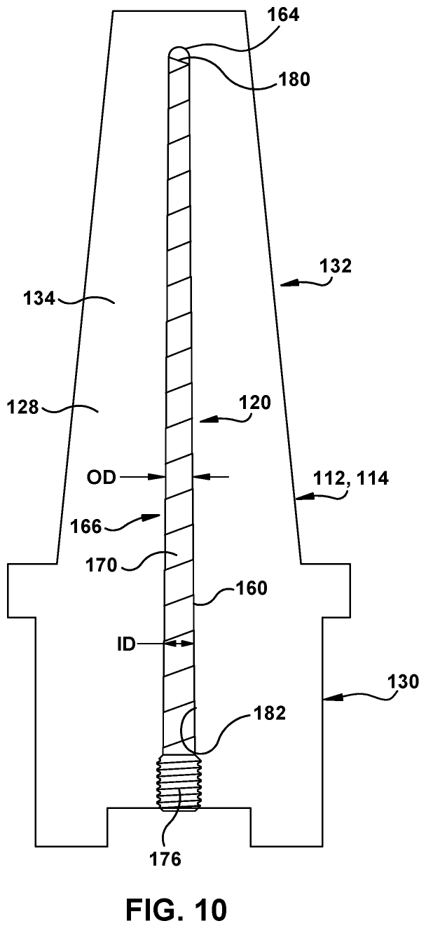

Vibration damping system 120 for nozzles 112 or blades 114 may include a vibration damping element 166 disposed in body opening 160. Vibration damping element 166 may include a volute spring vibration damping element 170 (herein “volute spring 170”) within body opening 160 in turbomachine nozzle 114 or blade 114. FIG. 7 shows an enlarged perspective view of a first, free end 180 of volute spring 170; FIG. 8 shows an enlarged cross-sectional view of part of volute spring 170; FIG. 9 shows a schematic cross-sectional view of part of volute spring 170; and FIG. 10 shows a schematic cross-sectional view of nozzle 112 or blade 114 including vibration damping system 120, according to embodiments of the disclosure.

As shown in FIGS. 5-10, volute spring 170 includes a spiral coil of a metal sheet strip 174 with a surface(s) 178 of metal sheet strip 174 contacting itself in a direction of an axis A of the coil. Hence, surface(s) 178 of metal sheet strip 174 frictionally engage with itself to dampen vibration. Volute spring 170 may also be referred to as a ‘conical spring.’ (It is emphasized that a shape of body opening 160 may vary from being perfectly conical (more accurately, frustoconical) and may alter a perspective shape of volute spring 170 from exactly conical, e.g., some axial curvature may be possible). Metal sheet strip 174 is arranged such that a length of a surface (longer surface of metal sheet strip 174) thereof extends generally axially and faces inwardly or outwardly, so the surfaces contact one another along a generally axially extending interface. (Volute spring 170 and metal sheet strip 174 thereof can be contrasted with a helical metal ribbon spring where short edges of the metal sheet strip face outwardly and a length of the surface of the metal sheet strip is in contact along a radially extending interface).

More particularly, an outer surface 1780 of a coil of metal sheet strip 174 contacts an inner surface 1781 of another coil of metal sheet strip 174 as the sheet coils in a longitudinal direction, i.e., along an axis A of volute spring 170. Surfaces 178 of volute spring 170 contact each other and rub together, i.e., frictionally engage, during motion of nozzle 112 or blade 114 to dampen vibration. The coiling of volute spring 170 stores energy in the metal sheet strip 174 in a manner that the strip wants to uncoil to a relaxed state, which stores axially directed energy and radially outward directed energy. While a volute spring is typically used as a compression spring, i.e., under compression, the coils provide a reactive axial force, and it will be recognized that volute spring 170 is not necessarily employed for its reactive axial force. Rather, volute spring 170 is employed for its surface frictional engagement and for its radially outward reactive force. In the latter case, volute spring 170, as any volute spring, wants to uncoil to a relaxed state, which naturally creates a radially outward force. The radially outward force allows volute spring 170 to frictionally engage inner surface 162 of body opening 160 to further dampen vibration.

As shown in FIGS. 8 and 9, an axial extent of overlap (AO) of surfaces 178 of metal sheet strip 174 along an axial length of volute spring 170 can be user specified to provide any desired amount of frictional engagement. In addition, it will be recognized that the axial extent of overlap (AO) can be uniform along an axial length of volute spring 170 (see e.g., FIG. 9), or it may vary depending, for example, on the axial location of surfaces 178 (see e.g., FIG. 8—compare AO1 with AO2). In addition, a frequency of rotation of coils of metal sheet strip 174 can be user specified to provide any desired amount of frictional engagement. For example, FIGS. 5 and 8 show volute spring 170 with a relative high frequency of coils of metal sheet strip 174 (e.g., 1 round per 2 centimeters of length), while FIG. 10 shows volute spring 170 with a lower frequency of coils of metal sheet strip 174 (e.g., 1 round per 10 centimeters of length).

Body opening 160 has inner surface 162 having an inner dimension ID and volute spring 170 has an outer dimension OD sized to frictionally engage inner dimension ID of body opening 160 to dampen vibration during motion of nozzle 112 or blade 114. That is, the outer dimension OD of volute spring 170 rubs against, i.e., frictionally engages, inner surface 162 of body opening 160 to dampen vibration, e.g., during movement of airfoil 134 of nozzle 112 or blade 114. In certain embodiments, as shown best in FIGS. 5 and 6, body opening 160 and volute spring 170 each may have a circular cross-sectional shape and a conical perspective shape along at least a portion of respective lengths thereof. That is, volute spring 170 has an outward conical perspective shape, and body opening 160 has an inward conical perspective shape. The conical perspective shapes of both volute spring 170 and, more likely, body opening 160 may be configured/sized to ensure frictional engagement of outer dimension OD of volute spring 170 and inner dimension ID of body opening 160 along any desired extent of body opening 160, e.g., 50%, 75%, 100%. As noted, volute spring 170 naturally wants to diametrically expand, and may be sized to exert any desired radial force F against inner dimension ID, i.e., inner surface 162, of body opening 160, as it expands. A length of body opening 160 can be sized to ensure volute spring 170 retains a desired amount of radial force F therein, i.e., an end 164 of body opening 160 retains volute spring 170 with some level of compression therein to ensure the desired radial force is present therein.

Body opening 160 extends through body 128 of turbomachine nozzle or blade 112, 114 between tip end 132 and base end 130 thereof. Body opening 160 has an inner surface 162 and a closed end 164. As shown in FIGS. 3-6 and 10, volute spring 170 has first, free end 180 and a second end 182 fixed relative to one of base end 130 and tip end 132. As will be described herein, the extent of fixation of second end 182 may vary. First, free end 180 is free to move axially within body opening 160, i.e., as volute spring 170 expands axially during installing, and more importantly, as turbomachine nozzle or blade 112, 114 vibrates.

In FIGS. 3-5 and 10, second end 182 of volute spring 170 may be fixed relative to base end 130 of body 128 of turbomachine nozzle or blade 112, 114, and first, free end 180 extends towards tip end 132. In contrast, in FIG. 6, second end 182 of volute spring 170 is fixed relative to tip end 132 of body 128 of turbomachine nozzle or blade 112, 114, and first, free end 180 extends towards base end 130. Volute spring 170 may be fixed in any manner using closure or fixing member 176, 196. Any form of closure or fixing member 176, 196 may be provided to close body opening 160 and/or close body opening 160 and fixedly couple second end 182 of volute spring 170 relative to base end 130 or tip end 132.

Closure and fixing members 176, 196 may include any now known or later developed structure to fixedly couple second end 182 of volute spring 170 relative to base end 130 or tip end 132 in body opening 160, e.g., a plate with a fastener, threaded fastener, or a weld. In one example, closure and fixing members 176, 196 may fix second end 182 of volute spring 170 from rotating within body opening 160, and from pulling away from closure and fixing members 176, 196 toward tip end 132 of nozzle or blade 112, 114. Closure and fixing members 176, 196 also set a limit of expansion of second end 182 of volute spring 170 within body opening 160. In an alternative embodiment, volute spring 170 may have a second end 182 that is not fully fixed. In this case, closure and fixing members 176, 196 do not fully fix second end 182, e.g., from rotating or pulling way, but simply abut it to define an extent of axial expansion of volute spring 170.

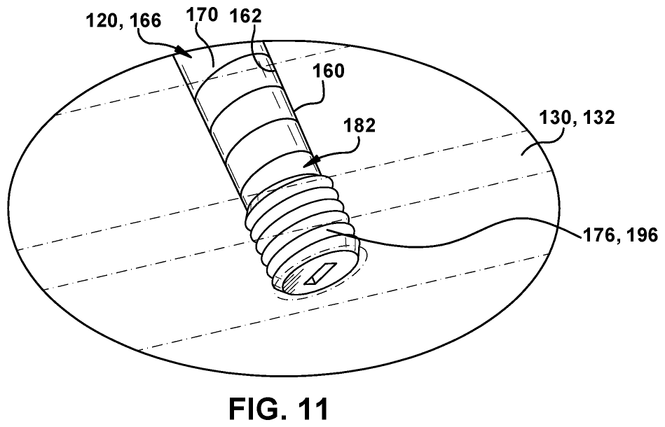

FIG. 11 shows a transparent perspective view of a closure and fixing member 176, 196 including a threaded fastener to fixedly couple second end 182 of volute spring 170 relative to base end 130 or tip end 132 in body opening 160 in any manner described herein. As observed by comparing closure and fixing member 176 in FIGS. 3-5, 10 and 11, a shape and size of closure and fixing member(s) 176, 196 can vary. The shape and size of closure and fixing member(s) 176 or 196 may depend on, for example, the turbomachine nozzle or blade 112, 114, body opening 160 size and shape, volute spring 170 size and shape, and force required to retain volute spring 170 against frictional and vibration forces applied thereto, among other factors.

Regarding the cross-sectional shapes of volute spring 170 and body opening 160, in one example shown in FIGS. 3-7, body opening 160 and volute springs 170 may have mating circular cross-sectional shapes. Further, they may both have conical perspective shapes, meaning they both decrease in diameter along their axial lengths. As noted, some variation from conical is possible.

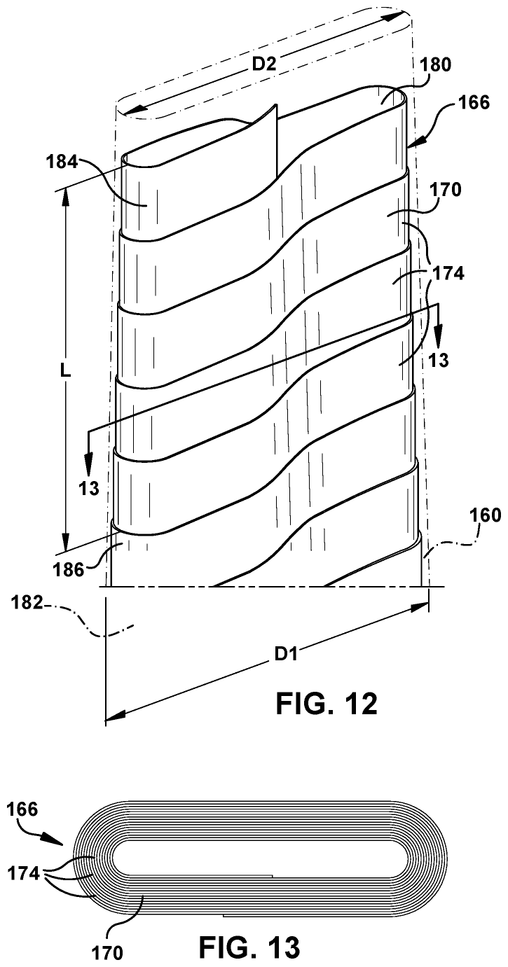

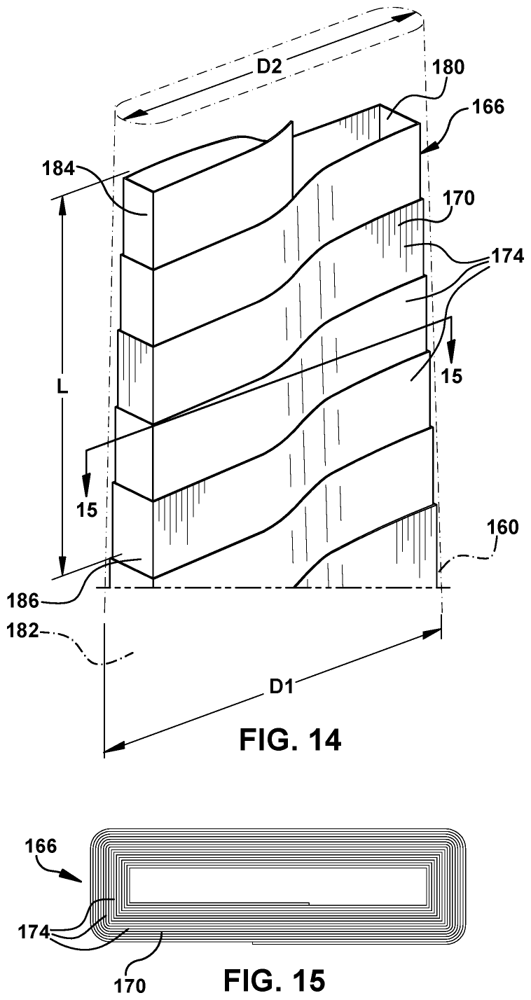

Alternately, other non-circular, mating cross-sectional shapes are also possible such as but not limited to oval or otherwise oblong; or polygonal such as square, rectangular, pentagonal; etc. FIG. 12 shows a perspective view, and FIG. 13 shows a cross-sectional view along view line 13-13 in FIG. 12 of a volute spring 170 that has an oblong or oval cross-sectional shape. FIG. 14 shows a perspective view, and FIG. 15 shows a cross-sectional view along view line 15-15 in FIG. 14 of a volute spring 170 that has a generally rectangular cross-sectional shape, e.g., rectangular but with rounded corners.

Regardless of cross-sectional shape, body opening 160 has a cross-sectional shape along its axial length L to mate with the cross-sectional shape of volute spring 170. A cross-sectional shape of body opening 160 may decrease in at least one dimension along its length to accommodate the corresponding decreasing dimensions of volute spring 170 along its axial length L. For example, as shown in FIGS. 12 and 14, body opening 160 may have an oblong cross-sectional shape, and may decrease in dimension D1, D2 to match a long axis of the oblong cross-sectional shape of volute spring 170. In this case, dimension D1 of body opening 160 (contacting a portion 184 of volute spring 170 radially distal from, for example, second, fixed end 182) is smaller than dimension D2 of body opening 160 (contacting a portion 186 of volute spring 170 radially proximate to fixed end 182). Note, fixed end 182 of volute spring 170 is shown with dashed line in FIGS. 12 and 14 because the end may be lower on the page than shown.

Metal sheet strip 174 of volute spring 170 may have any thickness sufficient to provide the desired vibration damping movement and requisite strength. In one non-limiting example, metal sheet strip 174 of volute spring 170 may have a thickness T (FIG. 8) of between approximately 0.76-2.54 millimeters (mm). Metal sheet strip 174 of volute spring 170 may be made of any material having the desired spring force and vibration resistance required for a particular application, e.g., a metal or metal alloy, which can withstand the operational environment of a turbine in which used. Volute springs 170 may also be coated in various coating materials to alter frictional properties thereof.

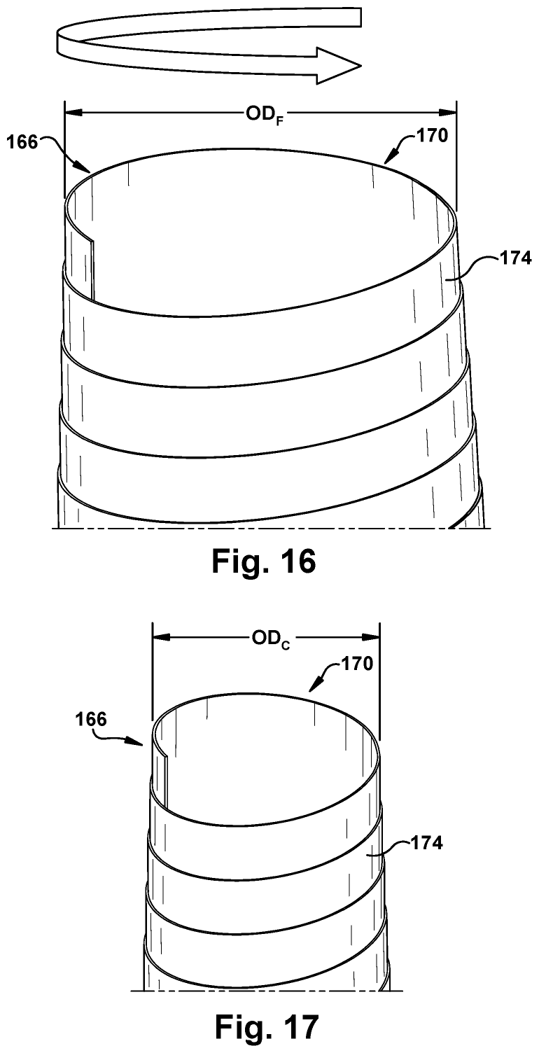

FIGS. 16-18 show part of a method of installing vibration damping element 166 in body opening 160 in turbomachine nozzle 112 or blade 114. FIG. 16 shows a perspective view of coiling volute spring 170 to a coiled position from a more relaxed position to reduce an outer dimension of volute spring 170 from a first (more free) outer dimension OD F to a second, smaller (coiled) outer dimension OD_{C}. FIG. 17 shows a perspective view of volute spring 170 in the coiled position. As shown in FIGS. 7 and 8, volute spring 170 includes a spiral coil of metal sheet strip 174 with surface 178 of the metal sheet strip contacting itself in a direction of an axis A of the coil.

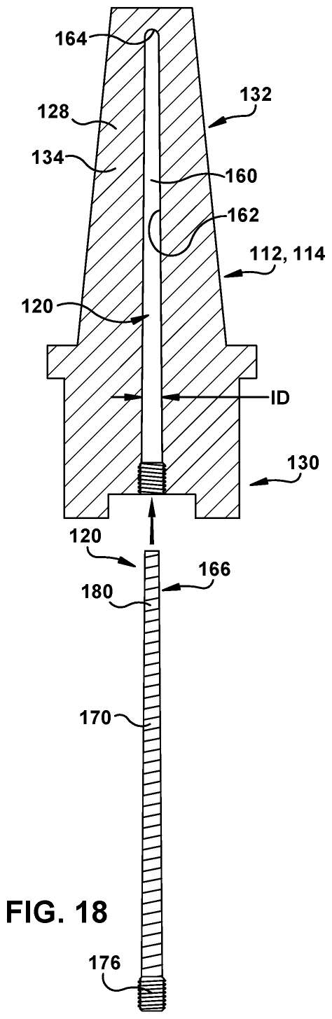

FIG. 18 shows positioning volute spring 170 within body opening 160 in turbomachine nozzle or blade 112, 114 in the coiled position (FIG. 17). As noted, body opening 160 has inner dimension ID that varies along its axial length to match (or nearly match) that of volute spring 170. During positioning, in one non-limiting example, a difference between outer dimension OD_{C} of volute spring 170 in the coiled position and inner dimension ID of inner surface 162 of body opening 160 may be in a range of approximately 0.06-0.08 millimeters (mm), which allows insertion of volute spring 170 but frictional engagement after release to a released position (FIGS. 5, 6) in body opening 160 (and during use and relative movement of airfoil 134 of nozzle 112 or blade 114).

FIGS. 5 and 10, for example, show volute spring 170 in a released position within body opening 160 such that an outer dimension OD of volute spring 170 frictionally engages ID of body opening 160. As will be described, in the released position in body opening 160, volute spring 170 dampens vibration during operation of turbomachine nozzle or blade 112, 114. As noted, volute spring 170 has a first, free end 180 and a second, fixed end 182, and body opening 160 extends through body 128 of turbomachine nozzle or blade 112, 114 between tip end 132 and base end 130 thereof. As explained, the method may further include fixing second end 182 of volute spring 170 relative to one of base end 130 and tip end 132 of the turbomachine nozzle or blade 112, 114, e.g., using closing and fixing member 176 or 196.

During operation of turbomachine nozzle 112 or blade 114, vibration damping element 166 of vibration damping system 120 operates with tip end 132, i.e., of airfoil 134, driving relative motion with base end 130 of nozzle 112 or blade 114. Here, vibration damping system 120 allows vibration damping via the relative motion through the deflection of tip end 132 and frictional engagement of volute spring 170 with itself and/or inner surface 162 of body opening 160. In the FIGS. 3-5 and 10 embodiments, vibration damping system 120 operates with first, free end 180 of volute spring 170 moving with tip end 132, i.e., with airfoil 134, driving relative motion with base end 130 of nozzle 112 or blade 114. FIG. 6 shows vibration damping system 120 operating with fixed end 182 of volute spring 170 moving with tip end 132, i.e., with airfoil 134, driving relative motion with base end 130 of nozzle 112 or blade 114. In any event, vibration damping system 120 also allows vibration damping through deflection of volute spring 170 and frictional engagement of surfaces 178 thereof with each other and/or inner surface 162 of body opening 160.

The vibration damping system 120 can be customized in a number of ways including, but not limited to: the size, coating(s), thickness(es), and material(s) of metal sheet strip 174 of volute spring 170; the number of coils of volute spring 170; the shape of coils of volute spring 170; the amount of radial force exerted by volute spring 170; and amount of axial overlap of surfaces 178 of volute spring 170 as controlled by, for example, the axial length of volute spring 170 (FIG. 13) compared to that of body opening 160.

According to various embodiments, a method of damping vibration in turbomachine nozzle 112 or blade 114 during operation of turbomachine nozzle 112 or blade 114 may include providing various levels of different vibration damping. For example, a method may dampen vibration by deflection of volute spring 170 disposed radially in body opening 160 and extending between tip end 132 and base end 130 of body 128 of turbomachine nozzle 112 or blade 114. As noted, volute spring 170 may include first, free end 180 and second, fixed end 182 fixed relative to base end 130 or tip end 132 of body 128. The method may also dampen vibration by frictional engagement of surfaces 178 of volute springs 170 with each other and/or with inner surface 162 of body opening 160. The surface contact of surfaces 178 of volute springs 170 creates friction, thus dissipating the input energy from the vibration. The frictional forces may also restrict motion of volute spring 170, thus reducing displacement. For rotating blades 114, damping of vibration by frictional engagement may be increased compared to nozzle 112 based on the centrifugal force increasing a force of frictional engagement of surfaces 178 of volute spring 170 with each other and/or with inner surface 162 of body opening 160.

It will be apparent that some embodiments described herein are applicable mainly to rotating turbomachine blades 114 that experience centrifugal force during operation and thus that may require certain structure to maintain high performance vibration damping. That said, any of the above-described embodiments can be part of a turbomachine nozzle 112 or blade 114.

Embodiments of the disclosure provide vibration damping element(s) 166 including volute spring vibration damping element 170 to reduce nozzle 112 or blade 114 vibration with a simple arrangement. Vibration damping system 120 does not add much extra mass to nozzle(s) 112 or blade(s) 114, and so it does not add additional centrifugal force to a blade tip end or require a change in nozzle or blade configuration. Moreover, the presence of vibration damping system 120 can reduce stresses on nozzle 112 or blade 114, thereby extending the useful life of such components. The vibration damping element 170 reduces nozzle or blade vibration with a simple arrangement, which is easily installed. The vibration damping element 170 is lightweight and does not add much extra mass to the nozzle or blade so that it generates low additional G-forces during use. The vibration damping system 120 may be applied to new nozzles or blades, or may be retrofitted by, for example, drilling a new body opening 160 therein.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” is not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described to best explain the principles of the disclosure and the practical application and to enable others of ordinary skill in the art to understand the disclosure for various embodiments with various modifications as are suited to the particular use contemplated.

1-9. (canceled)

10. A turbomachine nozzle or blade having a vibration damping system, the turbomachine nozzle or blade comprising:
a body opening extending through a body of the turbomachine nozzle or blade between a tip end and a base end thereof; and
a vibration damping element disposed in the body opening, the vibration damping element including a volute spring vibration damping element configured to be mounted within the body opening, the volute spring vibration damping element including a spiral coil of a metal sheet strip with a surface of the metal sheet strip contacting itself in a direction of an axis of the spiral coil;
wherein the body opening has an inner dimension, and the volute spring vibration damping element has an outer dimension sized to frictionally engage the inner dimension of the body opening to dampen vibration.

11. The turbomachine nozzle or blade of claim 10, wherein the body opening and the volute spring vibration damping element each have a conical perspective shape along at least a portion of respective lengths thereof.

12. The turbomachine nozzle or blade of claim 10, wherein the surface of the metal sheet strip frictionally engages with itself to dampen vibration.

13. The turbomachine nozzle or blade of claim 10, wherein the volute spring vibration damping element has a first, free end and a second end fixed relative to one of the base end and the tip end.

14. The turbomachine nozzle or blade of claim 13, further comprising a fixture member secured to the second end of the volute spring vibration damping element to prevent the volute spring vibration damping element from rotating within the body opening and from pulling away from the fixture member.

15. The turbomachine nozzle or blade of claim 13, wherein the second end of the volute spring vibration damping element is fixed relative to the tip end of the body of the turbomachine nozzle or blade, and the first, free end extends towards the base end.

16. The turbomachine nozzle or blade of claim 13, wherein the second end of the volute spring vibration damping element is fixed relative to the base end of the body of the turbomachine nozzle or blade, and the first, free end extends towards the tip end.

17. The turbomachine nozzle or blade of claim 10, wherein the volute spring vibration damping element and the body opening having mating circular cross-sectional shapes.

18. The turbomachine nozzle or blade of claim 10, wherein the volute spring vibration damping element and the body opening having mating non-circular cross-sectional shapes.

19. A method of installing a vibration damping element in a body opening in a turbomachine nozzle or blade, the method comprising:
coiling a volute spring vibration damping element to a coiled position from a free position to reduce an outer dimension of the volute spring vibration damping element from a first outer dimension to a second, smaller outer dimension, the volute spring vibration damping element including a spiral coil of a metal sheet strip with a surface of the metal sheet strip contacting itself in a direction of an axis of the coil;
positioning the volute spring vibration damping element in the coiled position within the body opening in the turbomachine nozzle or blade, the body opening having an inner dimension; and
releasing the volute spring vibration damping element in the body opening such that a third outer dimension of the volute spring vibration damping element frictionally engages the inner dimension of the body opening,
whereby the volute spring vibration damping element dampens vibration during operation of the turbomachine nozzle or blade.

20. The method of claim 19, wherein the volute spring vibration damping element has a first end and a second end, and the body opening extends through a body of the turbomachine nozzle or blade between a tip end and a base end thereof, and further comprising fixing the second end of the volute spring vibration damping element relative to one of the base end and the tip end of the turbomachine nozzle or blade.
